(19) United States
(12) Patent Application Publication
(10) Pub. No.: US 2009/0198619 A1
(43) Pub. Date: Aug. 6, 2009

(54) AGGREGATED HASH-CHAIN MICROPAYMENT SYSTEM

(75) Inventors: Mahesh V. Tripunitara, Elgin, IL (US); Thomas S. Messerges, Schaumburg, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 12/026,694

(22) Filed: Feb. 6, 2008

(51) Int. Cl. G06Q 20/00; H04L 9/32; G06Q 40/00

(52) U.S. Cl. 705/71; 705/75; 705/44

(57) ABSTRACT

Disclosed are a system and method for aggregating micropayment hash chains. An end user (the “payer”) cryptographically signs “commitments” and transmits then to a vendor. The commitments include an “accumulated count” field which tracks the total number of micropayments made thus far in the payment transaction between the payer and the vendor. The payer can also transmit payment tokens to the vendor. These payment tokens include micropayments verified by a hash chain. When the vendor seeks reimbursement from a broker, the vendor tells the broker the total number of micropayments in the payment transaction and sends verification information to the broker. The broker checks this information against a verification system established with the payer. If the information is verified to be correct, then the broker reimburses the vendor for the services provided and charges the payer. The verification information ensures that the payer and vendor cannot cheat each other.

### FIELD OF THE INVENTION

The present invention relates generally to computer communications, and, more particularly, to encryption-based methods for transferring micropayments.

### BACKGROUND OF THE INVENTION

Electronic commerce continues to grow at a tremendous pace. New communications technologies, such as WiFi and WiMax, decrease the costs of providing network services (such as cellular voice services and wireless data services), leading to a greatly increased number of service providers. Previous network models, where a few large central carriers controlled their networks and charged for access to them, are being supplanted by a model including many disparate providers. Commercial and financial models also change. For example, as roaming between service providers becomes more frequent, selection of a carrier might be negotiable on the spur of the moment and may even be negotiable during a call or data session. With a large and ever changing number of service providers, it becomes difficult, if not impossible, for each service provider to establish business relationships with all other service providers. Without these pre-established arrangements to reconcile charges, brokers step forward to handle billing. Service providers work with brokers to get reimbursed for the services they provide, end customers reimburse the brokers, and brokers extract fees for processing the payments.

The increased number of service providers also changes the financial model with respect to end customers. While interacting with these various service providers, a customer makes numerous small payments for service. Traditional methods for reconciling payments (e.g., credit-card systems) are not appropriate to these “micropayments,” because the cost overhead of reconciling each payment would swamp the value of the micropayment itself.

Micropayment systems have been proposed to handle these small, incremental payments in a manner cost-effective both to the end customers and to the vendors. Some of these systems use a cryptographic construct called a “hash chain.” A hash chain is generated by repeated applications of a cryptographic hash function. Each entry in a hash chain is then used to verify a micropayment. A broker verifies the micropayments, reimburses the vendor, and charges the end customer. Because cryptographic hash chains allow a service provider or vendor to aggregate individual micropayments, he saves on transaction costs with the broker. A hash-chain-based system also provides for non-repudiation and prevents fraudulent accounting by service providers and vendors.

### BRIEF SUMMARY OF THE INVENTION

The above considerations, and others, are addressed by the present invention, which can be understood by referring to the specification, drawings, and claims. According to aspects of the present invention, micropayments are represented by individual hash-chain members. The hash chains are then aggregated to provide a more efficient data exchange between a vendor and a broker.

In one embodiment, an end user (here called the “payer”) cryptographically signs “commitments” and transmits then to a vendor (i.e., a network-service provider). Each commitment includes an anchor of a hash chain and an “accumulated count” field which tracks the total number of micropayments made thus far in the payment transaction between the payer and the vendor. The payer can also transmit payment tokens to the vendor. Each payment token includes an element of the hash chain, the hash chain being secured by the anchor included in the commitment.

When the vendor seeks reimbursement from a broker, the vendor tells the broker the total number of micropayments in the payment transaction. (The number may be based, for example, on the accumulated count in the last commitment of the payment transaction plus any micropayments made in payment tokens after the last commitment). The vendor need not send every intervening commitment to the broker. This saves on transmission costs between the vendor and the broker and on storage costs for both of them.

In some embodiments, a verification system is established between the broker and the payer. The commitments transmitted by the payer to the vendor include information tied to this verification system. (For example, the verification information can include a timestamp or a counter.) The vendor checks the authenticity of the payer's commitments and micropayments. In turn, the vendor sends verification information to the broker. The broker checks this information against the verification system established with the payer. If the information is verified to be correct, then the broker reimburses the vendor for the services provided and charges the payer. The verification information ensures that the payer and vendor cannot cheat each other by, for example, repudiating legitimate payments or by submitting the same information for multiple reimbursements.

### BRIEF DESCRIPTION OF THE SEVERAL VIEWS OF THE DRAWINGS

While the appended claims set forth the features of the present invention with particularity, the invention, together with its objects and advantages, may be best understood from the following detailed description taken in conjunction with the accompanying drawings of which:

FIG. 1 is a sketch showing the three parties in a payment transaction;

FIG. 2 is a sketch of a prior-art technique of using hash chains to make micropayments;

FIG. 3 is a sketch of a payment transaction according to aspects of the present invention;

FIG. 4 is a flowchart of a payer interacting with a vendor according to an exemplary embodiment of the present invention;

FIG. 5 is a flowchart of a vendor interacting with a payer and with a broker;

FIG. 6 is a flowchart of a broker interacting with a vendor;

FIG. 7 is a graph comparing the amount of processing time required of a broker under a prior-art system and under a system according to the present invention;

FIG. 8 is a graph comparing the amount processing time required of a payer under a prior-art system and under a system according to the present invention; and

FIG. 9 is a graph comparing the amount of storage required of a vendor under a prior-art system and under a system according to the present invention.

### DETAILED DESCRIPTION OF THE INVENTION

Turning to the drawings, wherein like reference numerals refer to like elements, the invention is illustrated as being implemented in a suitable environment. The following description is based on embodiments of the invention and should not be taken as limiting the invention with regard to alternative embodiments that are not explicitly described herein.

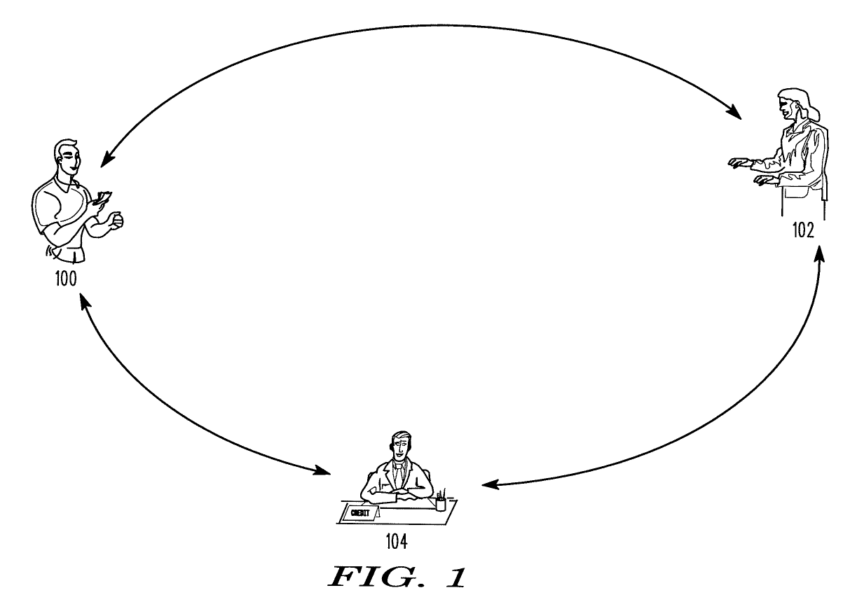

FIG. 1 introduces the players and the interactions among them that together make up a payment/reimbursement transaction. A payer 100 wishes to buy services from a vendor or service provider 102. The types of services are not relevant to the present invention but could include telephony services, access to web-based content, and the like. The payer 100 sends digital payment indications (discussed in great detail below) to the vendor 102 who, in turn, provides the requested services. At the end of a payment transaction between the payer 100 and the vendor 102, the vendor 102 seeks reimbursement from the broker 104. The broker 104 checks verification information provided during the payment transaction and, if all is well, reimburses the vendor 102 and bills the payer 100. In some systems, the payer 100 first establishes an account with the broker 104 and sets up a system for verifying payments. The payer 100 uses some mechanism (beyond the scope of FIG. 1) to pay the broker 104 when the broker 104 bills him for the services the payer 100 has purchased from the vendor 102.

Many known prior-art systems use a cryptographic hash function to make micropayments. This hash function, h: {0,1}*→{0,1}ⁿ, maps a variable-length input to a fixed-length output. It is intended to be a practical realization of a random function. While it is easy to compute, it is very difficult to invert. SHA-1 is a well known example of such a hash function; it produces a 160-bit output. A hash chain of e entries is of the form e₀, e₁, . . . , e_{c}, e_{c+1}, where e₀ is called the anchor of the hash chain, e_{c+1} is a (virtually) random number, and eᵢ=h(ei+1) for the hash function h( ).

Hash chains were first proposed in the context of one-time passwords and have since been proposed for micropayments. In the context of micropayments, each entry in the hash chain is used as a payment worth some pre-determined amount. Specifically, prior-art micropayment techniques often include the following steps. (These steps, modified as appropriate, are also used in the discussion below to describe embodiments of the present invention.)
Step 1: The broker 104 issues a certificate C_{U} to the payer 100. This is an offline step that happens infrequently relative to the number of payments that the payer 100 makes. At a minimum, C_{U} includes <B, U, Pub_{U}, E>, where B identifies the broker 104, U identifies the payer 100 (e.g., by an account number), Pub_{U} is the public portion of a public-private key pair associated with the account of the payer 100, and E is the expiration date of the certificate. C_{U} represents an assurance to a vendor 102 that the broker 104 will reimburse the vendor 102 for payments made by the payer 100.
Step 2: The payer 100 initiates a payment transaction with the vendor 102. To do so, the payer 100 generates a hash chain e₀, . . . , e_{c+1}. (In other cases, the hash chain is generated by the broker 104.) The payer 100 commits to e0 by signing a suitable commitment message M with the private portion of his public-private key pair, Priv_{U}. The payer 100 then sends the message M to the vendor 102, perhaps along with C_{U}. This message M gives context to the payment transaction. It typically includes <V, U, e₀, D, A>, where V identifies the vendor 102, U identifies the payer 100 (e.g., by an account number as described above), e₀ is the anchor of the hash chain that the payer 100 intends to use for payments, D is the current date, and A is additional information such as a description of the services or goods that the payer 100 wishes to buy from the vendor 102 and the value associated with each entry in the hash chain. During the payment transaction, the payer 100 makes the ith payment by sending a payment token including ei. to the vendor 102.
Step 3: The vendor 102 accepts a payment from the payer 100 after verifying it. Upon receipt of the commitment message M, the vendor 102 verifies the signature on M and may check with the broker 104 to see whether C_{U} is still valid. Upon receipt of subsequent payments eᵢ, the vendor 102 verifies that eᵢ₋₁=h(eᵢ). The vendor 102 then provides goods or services to the payer 100. The payer 100 does not have to explicitly indicate to the vendor 102 when he is done using the services.
Step 4: The vendor 102 requests reimbursement from the broker 104 by sending to the broker 104 a message <M, eᵢ, i> for each M to which the payer 100 has committed. Here, i is the index of the last payment made in the corresponding payment transaction.
Step 5: The broker 104 verifies what the vendor 102 sends him.

Specifically, the broker 104 checks that the signatures, the fields in the commitments, and the hash chains are valid, and that no previously used hash chain has been reused. The broker 104 then reimburses the vendor 102 and bills the payer 100.

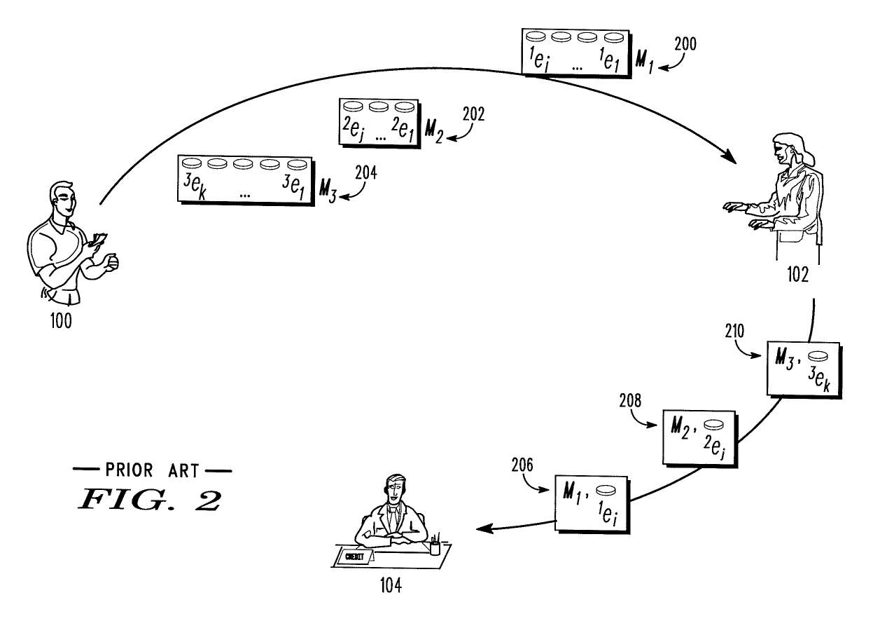

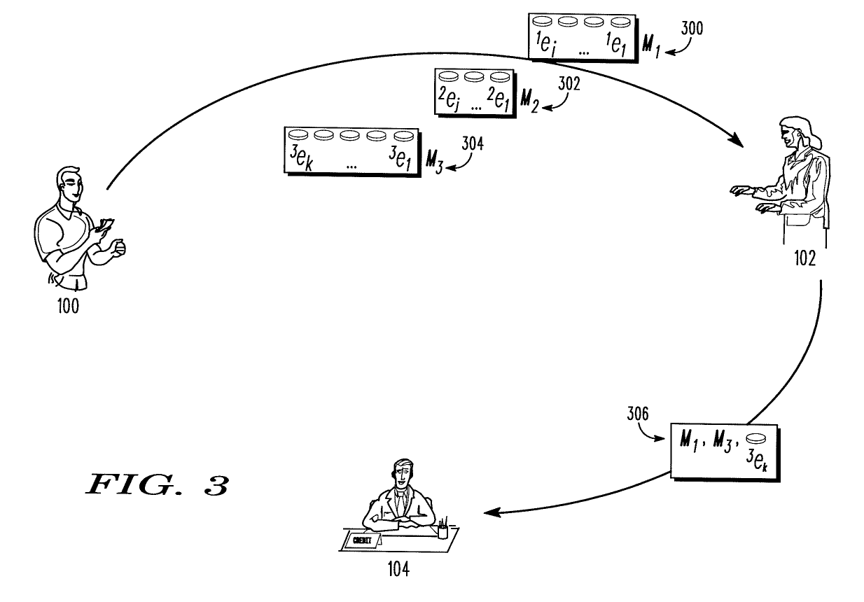

FIG. 2 illustrates Steps 2 and 4 of the above prior-art system. In FIG. 2, the payments 200, 202, and 204 each include a commitment message. The payments 200, 202, and 204 also include entries from three hash chains of lengths i, j, and k, respectively. The vendor 102 requests a reimbursement 206, 208, and 210 for each of these hash chains. To do so, the vendor 102 only needs to send to the broker 104 the final entry in each hash chain along with the corresponding commitment.

By using hash chains for micropayments, several payments fall within the scope of a single signature operation. The vendor 102 benefits because he only has to perform (a) one hash operation for every payment and (b) one signature verification for the initial commitment. Also, the hash-chain payments are aggregated at the vendor 102. That is, if the vendor 102 has already been paid e₁, . . . , eᵢ₋₁, and is then paid eᵢ, then the vendor 102 only needs to store eᵢ and not all of the previous payments. This is because the hash function is assumed to have the property that eᵢ₋₁ can be generated efficiently only by someone that possesses eᵢ, and furthermore, it is difficult to find some other eⱼ such that h(eⱼ)=eᵢ₋₁. This aggregation decreases the amount of data that the vendor 102 needs to send to the broker 104 when requesting reimbursement. Similarly, the broker 104 has reduced computation costs as he only needs to verify the signature on every commitment and not on every payment. Hash chains also reduce the computation needed in the device of the payer 100 as not every payment needs to be signed.

However, the prior-art system of FIG. 2 also has some disadvantages. To achieve the greatest efficiency, the payer 100 must guess the length of the hash chain he intends to use to make payments. There are tradeoffs related to time and space that the payer 100 considers in choosing the length. If he chooses a hash chain that is too short, then he needs to generate a new hash chain and a signature to continue paying the vendor 102. If he generates a hash chain that is too long, then he wastes either storage space to store the hash chain or processing power to regenerate hash-chain entries “on the fly.” Such time-space tradeoffs are important issues because many payers 100 use a portable device such as a mobile phone or PDA with limited storage and processing power.

The choice of hash-chain length also affects the vendor 102 and the broker 104. In the example from FIG. 2, if the payer 100 had chosen a single hash chain of length at least i+j+k, then the vendor 102 would have had to use only a third as much processing time and storage space. In the reimbursement transaction, the vendor 102 transfers all of these commitments to the broker 104. In a more extreme example, if the payer 100 makes 10,000 micropayments each worth a tenth of a penny and chooses a hash-chain length of 10, then the vendor 102 will store 1,000 commitments for a $10 payment transaction. The vendor 102 transfer all of these commitments to the broker 104 when requesting reimbursement. The broker 104 verifies every hash-chain member and therefore, in this example, the broker 104 performs 10,000 hash verifications. Even though hash functions are generally much easier to verify than public-key signatures, the broker 104 has to perform considerable computations for each payment transaction. This is in addition to the 1,000 public-key signature verifications that correspond to the 1,000 hash chain commitments. Finally, to prevent double spending, the vendor 102 and the broker 104 each stores (the hash of) each reimbursed commitment.

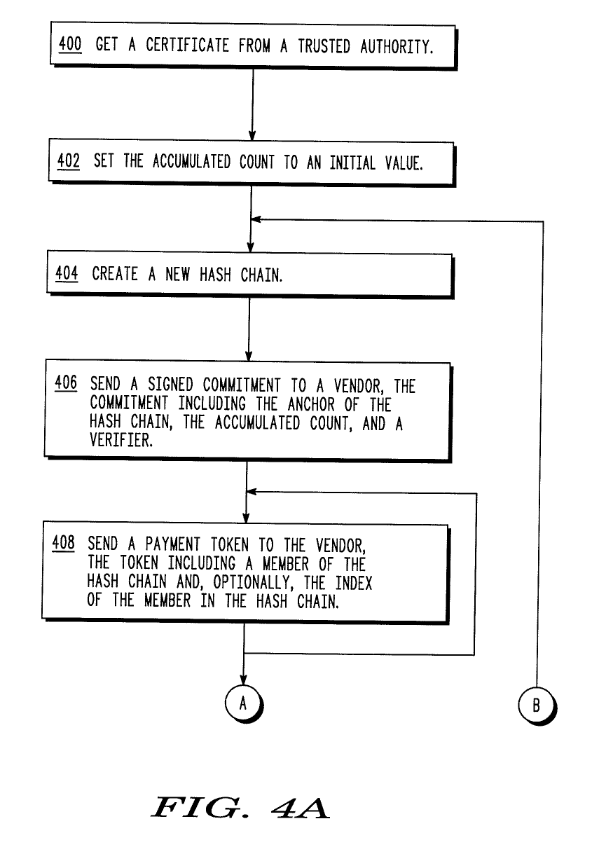

In contrast to the prior-art techniques discussed above and illustrated by FIG. 2, the following discussion and FIGS. 3 through 6 illustrate a few embodiments of the present invention. Aspects of the present invention improve upon prior-art techniques by providing two levels of aggregation: (a) each hash-chain aggregates individual payments and (b) hash chains are themselves aggregated in one payment transaction. These aggregations are possible because the hash chains are themselves not important to the vendor 102 and the broker 104; the importance lies in the value of the micropayments represented by the hash chains.

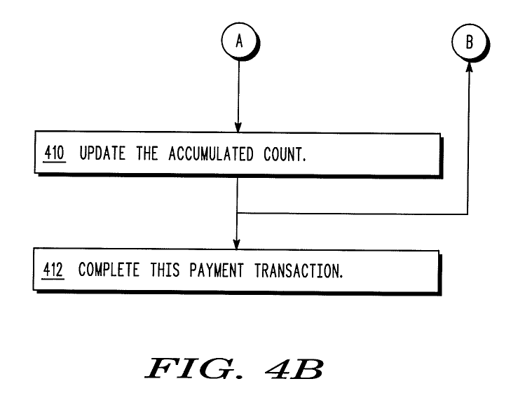

Step 1 of an embodiment of the present invention is similar to Step 1 as described above: The payer 100 receives a certificate from a trusted authority which could be, but need not be, the broker 104. (See Step 400 of FIG. 4a.)

Step 2 in the present embodiment can differ from the above described Step 2 in numerous ways. First, a commitment includes three new fields. One field is called the “accumulated count,” a second field is the “verifier,” and a third field is a “transaction identifier.” (Various embodiments exclude one or more of these fields, as discussed in detail below. The present discussion is meant to be broadly illustrative rather than limiting.) Second, Step 2 can be repeated within one payment transaction, that is, a single payment transaction can include multiple commitments.

To illustrate these points, in the prior-art technique of FIG. 2, each hash chain 200, 202, and 204 used by the payer 100 to make micropayments to the vendor 102 leads to a separate reimbursement transaction 206, 208, and 210 between the vendor 102 and the broker 104. In contrast, one reimbursement transaction 306 in FIG. 3 corresponds to multiple hash chains 300, 302, and 304. The accumulated count field allows this aggregation. The accumulated count field is initialized before any commitments are sent (Step 402 of FIG. 4a). Whenever a new hash chain is needed in the payment transaction (Step 404), a new commitment with the new hash-chain anchor and the accumulated count is sent to the vendor 102 (Step 406). In this commitment, the accumulated count records the number of micropayments made thus far in the payment transaction. For example, the accumulated count can be set to 0 in the first commitment that sets up the first hash chain 300. When the second commitment is sent to set up the second hash chain 302, the accumulated count is set to i, the number of micropayments made under the first hash chain (Step 410 of FIG. 4b). Again, when the third commitment is sent to begin the third hash chain 304, the accumulated count is set to i+j. The effect of the accumulated count on the reimbursement transaction 306 is discussed below in reference to Steps 4 and 5.

As in the prior-art technique, for each hash chain, the payer 100 can send payment tokens to the vendor 102, each token including a member of the current hash chain to indicate payment (Step 408 of FIG. 4a).

In some embodiments, the first commitment in a payment transaction either does not include an accumulated count (in which case it is assumed to be zero), or it includes a non-zero (possibly random) number. These cases are described below in the discussion of Steps 4 and 5.

In some embodiments, the accumulated count allows the commitments to replace some or all of the payment tokens. Because the accumulated count tracks the number of micropayments made in the payment transaction between the payer 100 and the vendor 102, the payer 100 can indicate payments simply by sending the commitments rather than by sending payment tokens. The accounting for payments is discussed below in reference to Steps 4 and 5.

The verifier field is used differently in different embodiments of the present invention. In one embodiment, the verifier is a timestamp that records the relative or actual time when a commitment is made. (In this case, the date field D discussed above may be redundant.) The timestamp is of sufficient granularity that no two commitments in the same payment transaction between the payer 100 and the vendor 102 can have the same value. Furthermore, for two commitments M₁ and M₂ in the same payment transaction, where M₁ is sent before M₂, the timestamp in M₁ is smaller than the timestamp in M₂. Some embodiments use the current time (in GMT, say) to a sufficient granularity for the verifier timestamp. In other embodiments, the verifier field is an ordered counter. The counter is checked to make sure that it always progresses monotonically in a pre-agreed manner (e.g., always increases or always decreases) from one commitment to the next within a given payment transaction.

Some embodiments include a transaction identifier field in each commitment. This is useful if the vendor 102 intends to support concurrent payment transactions with the payer 100. In the prior-art technique, the anchor of the hash chain can serve as a transaction identifier. In some embodiments of the present invention, the anchor of the first hash chain in a payment transaction can work as well, as long as the payer 100 does not attempt to reuse that hash chain.

Calculations predict that 32 bits are sufficient for each of the accumulated count and transaction identifier fields, and 64 bits are sufficient for the verifier. (The 64-bit representation of time in version 4 of the Network Time Protocol, for example, provides a resolution of up to a fraction of a nanosecond.) Consequently, embodiments of the present invention increase the size of each commitment by only 16 bytes (for embodiments that include all three new fields).

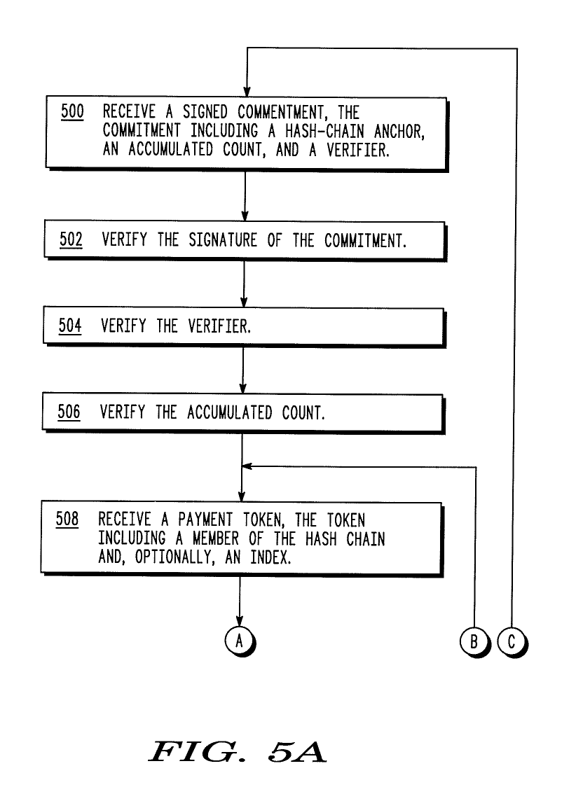

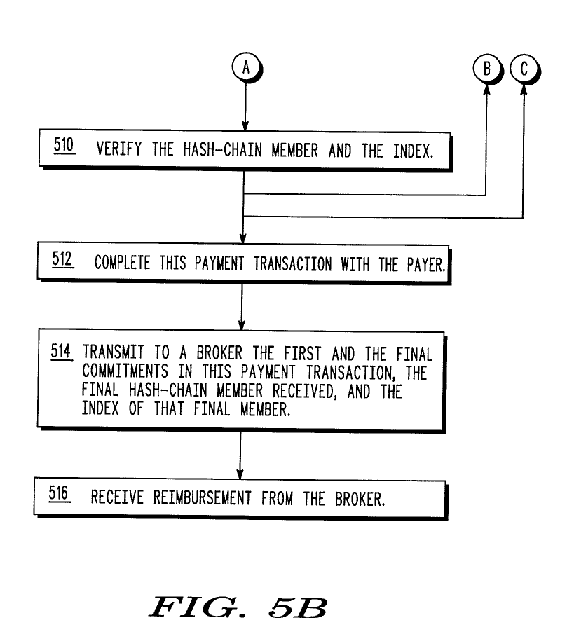

Moving on to Step 3, in embodiments of the present invention, the vendor 102 can receive multiple commitments in one payment transaction (Step 500 of FIG. 5a). For each commitment, the vendor 102 can choose to verify the information in the commitment including the signature of the payer 100 (Step 502), the verifier (Step 504), and the accumulated count (Step 506). As discussed above, the payer 100 can send payment tokens to the vendor 102 (Step 508), but in some embodiments the accumulated count in the commitments replaces some or all of these payment tokens. If the vendor 102 receives a payment token (Step 508), then the vendor 102 can verify that the included hash-chain member is in fact a valid member of the hash chain set up by the most recently received commitment (Step 510 of FIG. 5b).

In Step 4, the vendor 102 seeks reimbursement from the broker 104 for the payment transaction. In the prior-art technique of FIG. 2, the vendor 102 has to send one reimbursement request 206, 208, 210 for each hash chain 200, 203, 204 used in the payment transaction. However, in the embodiment of the present invention illustrated in FIG. 3, the vendor 102 aggregates these requests into one reimbursement request 306. In sending this reimbursement request 306, the vendor 102 provides to the broker 104 information that allows the broker 104 to determine the amount of the reimbursement and information that allows the broker 104 to confirm the validity of the reimbursement. In one embodiment, the reimbursement request message 306 includes <M₁, Mₙ, eᵢ, i> (Step 514 of FIG. 5b). M₁ is the first commitment in the payment transaction, Mₙ is the final commitment in the payment transaction, ei is the last entry in the hash chain corresponding to the anchor in Mₙ, and i is the index of eᵢ in that hash chain. The number of individual micropayments incurred by the payer 100 in this payment transaction is Cₙ+i, where Cₙ is the value of the accumulated count field in the final commitment Mₙ. Here, Cₙ represents the total number of micropayments made in the payment transaction before the final commitment Mₙ was sent, and i represents the number of micropayments in the payment transaction made after that final commitment Mₙ. A few special cases are worthy of note. (a) For some payment transactions, only one commitment is used, so that Mₙ is the same as M₁. (b) In some payment transactions, no payment tokens are sent to the vendor 102 after the final commitment Mₙ. In this case, the reimbursement request 306 can be <M₁, Mₙ>, and the number of micropayments is simply Cₙ. (c) As discussed above, in some cases the accumulated count is not set to zero before the payment transaction begins. In this case, the number of micropayments is equal to the difference between the accumulated count Cₙ in the final commitment Mₙ and the accumulated count C₁ in the first commitment M₁ (plus the index i representing payment tokens sent after the final commitment Mₙ, if any). (d) In some cases, the index i is not actually sent but is deduced by the broker 104. For example, the index i is equal to the number of times it takes to hash eᵢ to reach the e₀ contained in the commitment Mₙ.

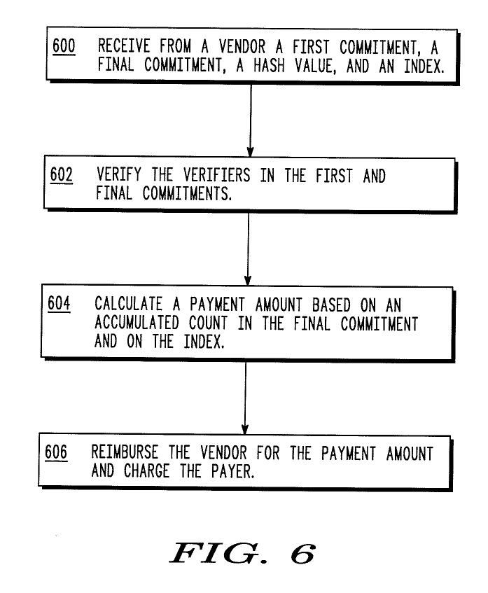

In Step 5, the broker 104 receives the reimbursement request 306 (Step 600 of FIG. 6) and proceeds to verify it. In some embodiments, the broker 104 first verifies that the first M₁ and final commitments Mₙ were indeed signed by the payer 100. Next, the broker 104 verifies the verifiers in the first M₁ and final commitments Mₙ (Step 602). In some embodiments, the broker establishes a “verifier threshold” for reimbursement requests 306. For every reimbursement request 306, the verifier in the first commitment M₁ should fall after this established verification threshold. Any reimbursement request 306 that violates this rule is rejected by the broker 104. In some embodiments, the broker 104 sets one verification threshold per payer 100, in other embodiments there is one per payer 100/vendor 102 pair, or one per payer 100/vendor 102/type of service triplet. (The choice is one of broker policy. The finer the granularity that the broker 104 supports, the more flexibility it provides to the vendor 102; however, this means that the broker 104 allocates more storage.) The broker 104 only has to store the verification threshold rather than, as in the prior-art technique, (the hashes of) all previous commitments. In some embodiments, the vendor 102 is aware of this verification threshold and uses it to verify the verifiers received in commitments (Step 504 of FIG. 5a). The broker 104 may then establish a new verification threshold for the next round of reimbursement requests 306. In some embodiments, the new verification threshold is the last verifier (e.g., the latest timestamp) across all of the final commitments in the current set of reimbursement requests 306 from the vendor 102.

If the reimbursement request 306 is verified to the satisfaction of the broker 104, then the broker 104 calculates the number of micropayments represented by the request 306. (Variations in this process are described above in reference to Step 4.) The broker 104 then translates this number of micropayments into a reimbursement amount (possibly minus a transaction fee) (Step 604 of FIG. 6), reimburses the vendor 102 (Step 516 of FIG. 5b and Step 606 of FIG. 6), and charges the payer 100.

The present inventions provides advantages in performance (storage space and processing time) over prior-art techniques. To illustrate these advantages, the following discussion compares an embodiment of the prior-art technique with an embodiment of the present invention. As different embodiments exhibit different performance characteristics, this discussion is illustrative only and is not meant to limit the invention in any way.

For personal communications devices such as cell phones and PDAs, tests indicate that generating a 163-bit ECC curve 3 signature takes roughly 100 times as long as generating a SHA-1 hash of 20 bytes. Also, verifying a signature takes about three times as long as generating the signature. (ECC is preferred over RSA signatures because of the limited computational ability of these personal devices.)

To calculate the time needed for the vendor 102 and the broker 104 to process payments, let p be the number of payments the payer 100 makes, h be the length of a hash chain, and r be the number of reimbursements that have already been processed for the payer 100 by the broker 104. Use the time needed to generate one hash as the unit of time. Let tₛ be the time needed to generate a signature and tᵥ the time to verify a signature. (As discussed above, tₛ=100 and tᵥ=300 for a 163-bit ECC curve 3 cryptosystem). In the prior-art technique, the time to process payments from a payer 100 at the vendor 102 and at the broker 104 is then:

T_{old}=P+┌p/h┐'(tᵥ+1)

where ┌ ┐ is the ceiling function. The p component represents the number of hashes to be verified. ┌p/h┐×tᵥ represents the number of commitments made by the payer 100 to make p payments and the signatures on those commitments that need to be verified. Finally, ┌p/h┐×1 represents the need to compute the hash of each commitment to compare with the hashes of prior commitments for payment transactions that have already been reimbursed. In contrast, in an embodiment of the present invention, the time to process p payments from the payer 100 at the vendor 102 is:

T_{v,new}=p+┌p/h┐×tᵥ.

The vendor 102 verifies p hashes and ┌p/h┐ commitments (signatures). He also verifies ┌p/h┐ verifiers, but that time is considered to be negligible when compared to the time required for the cryptography-related verifications. As the above formulas for T_{old} and T_{v,new} suggest, the difference between the processing times at the vendor 102 is attributable to the prior art's need to check against previous commitments. The advantage of embodiments of the present invention grows linearly with the ratio p/h.

In an embodiment of the present invention, the time to process these p payments at the broker 104 (when the vendor 102 files for reimbursement) is:

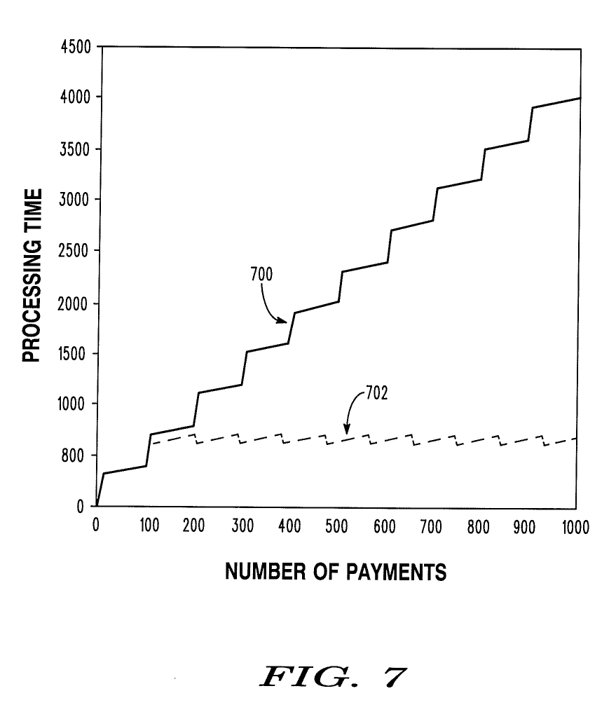

T_{b,new}=c×tᵥ+(p mod h)+(1+└p/h┘−┌p/h┐)×h

where c is 1 if p≦h, and 2 otherwise, and mod is the modulo operator (the remainder after dividing p by h). The c×tᵥ component comes from the fact that the broker 104 verifies only one commitment if p≦h and two commitments otherwise. The remainder of the expression is the number of hashes that the broker 104 verifies for entries from the hash chain associated with the final commitment. These calculations show that for the broker 104 the difference between the prior-art and present techniques is quite pronounced. FIG. 7 plots the processing time (hashing and signature verification) for payments at the broker 104 for the prior-art (curve 700) and for an embodiment of the present invention (curve 702). FIG. 7 indicates that given a hash chain length h, and the possibility that p may exceed h, it is beneficial for the vendor 102 and for the broker 104 to use an embodiment of the present invention rather than the prior-art technique. Also, in the embodiment of the present invention, given two hash-chain lengths h₁ and h₂ such that h₁<h₂, it is beneficial for the broker 104 that payments are made using hash chains of length h₁ rather than h₂ if p>h₂.

Turning to the payer 100, for a given hash chain length h, the processing time at the payer 100 is the same for the prior-art and the present techniques:

┌p/h┌(tₛ+h).

The payer 100 makes a tradeoff in choosing the length h of the hash chain. Because the payer 100 is not always able to predict exactly how many payments he will make, he runs the risk of generating a long hash chain and wasting either time or space or both. Embodiments of the present invention provide flexibility because the payer 100 can still choose relatively short hash chains and not waste processing time or space. To quantify the risk from the prior-art technique, consider two hash chain lengths, hₛ and h₁, with h₁>>hₛ. Consider the case where the payer 100 is willing to trade off time for space. If the payer 100 is willing to store at most hₛ hash-chain entries at one time, then, in the prior-art technique, the payer 100 regenerates hash-chain entries each time hₛ entries are exhausted. The total processing time at the payer 100 under the prior-art technique in this case is:

$$\begin{matrix}{T}_{u , old} = ⌈ p / {h}_{1} ⌉ \times {t}_{s} + ( ⌈ p / {h}_{1} ⌉ - 1 ) \times [ {h}_{1} + ( {h}_{1} - {h}_{s} ) + \\ ( {h}_{1} - 2 \times {h}_{s} ) + … + ( {h}_{1} - ( ⌈ min \{ p , {h}_{1} \} / {h}_{s} ⌉ - 1 ) \times {h}_{s} ) ] + \\ ( ⌈ p / h ⌉ - ⌊ p / h ⌋ ) \times [ {h}_{1} + ( {h}_{1} - {h}_{s} ) + ( {h}_{1} - 2 \times {h}_{s} ) + … + \\ ( {h}_{1} - ( ⌈ ( p mod {h}_{1} ) / {h}_{s} ⌉ - 1 ) \times {h}_{s} ) ] \\ \approx ⌈ p / {h}_{1} ⌉ \times ( {t}_{s} + {h}_{1} + ( {h}_{1} - {h}_{s} ) + ( {h}_{1} - 2 \times {h}_{s} ) + … + \\ ( {h}_{1} - ( ⌈ min \{ p , {h}_{1} \} / {h}_{s} ⌉ - 1 ) \times {h}_{s} ) ) \\ = ⌈ p / {h}_{1} ⌉ \times [ {t}_{s} + ⌈ min \{ p , {h}_{1} \} / {h}_{s} ⌉ \times {h}_{1} - \\ ( {h}_{s} \times ⌈ min \{ p , {h}_{1} \} / {h}_{s} ⌉ \times ( ⌈ min \{ p , {h}_{1} \} / {h}_{s} ⌉ - 1 ) ) / 2 ]\end{matrix}$$

In contrast, the processing time for the payer 100 when using an embodiment of the present invention is:

T_{u,new}=┌p/hₛ┐(tₛ+hₛ)

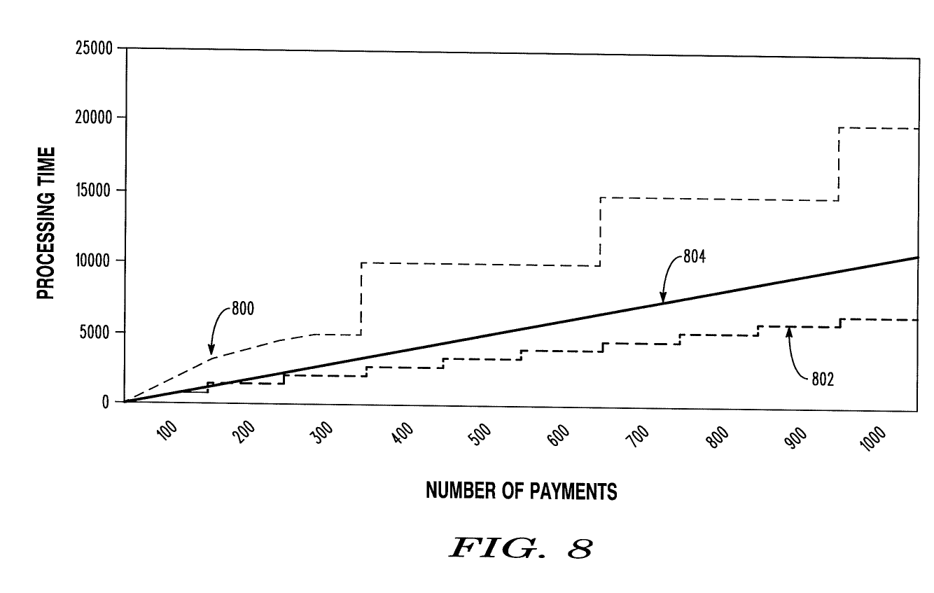

FIG. 8 plots the processing time of the payer 100 for the prior art with h₁=300 (curve 800), the prior art with h₁=100 (curve 802), and an embodiment of the present invention with hₛ=10 (curve 804). FIG. 8 demonstrates that it is not always in the best interest of the payer 100 to use longer hash chains.

If the payer 100 is willing to trade off space for time, then his space requirements go up commensurately. For example, when h₁=10×hₛ the payer 100 allocates ten times as much space. When hₛ=10, this is the difference between allocating 200 bytes and 2 megabytes (SHA-1 hashes are 20 bytes each). The latter can be a significant amount of storage to allocate to a single payment session.

The above discussion shows that embodiments of the present invention provide processing-time benefits to the vendor 102 and to the broker 104. For a given hash chain length, the prior-art and present techniques are identical in terms of processing time for the payer 100. However, embodiments of the present invention are still advantageous for the payer 100 because they perform well even with smaller hash chains. Smaller hash chains are beneficial to the payer 100 because he does not risk wasting processing time or storage space.

To compare the prior-art and present techniques from the standpoint of storage requirements at the broker 104, the vendor 102, and the payer 100, let sₕ be the space needed to store an entry from a hash chain, and let s_{c} be the space needed to store a commitment. When SHA-1 is the hash function, sₕ is 20 bytes for the hash plus 4 bytes for the index in the hash chain. The size of s_{c} includes the signature, which is about 60 bytes for a 163-bit curve 3 ECC cryptosystem; however, s_{c} includes whatever else is in the commitment, such as the (hash of the) service agreement between the payer 100 and the vendor 102. It is expected that s_{c} is about five times the size of sₕ.

The space required at the payer 100 for payments is the same in the prior-art and present techniques. The payer 100 needs to store the unspent entries from the hash chain. The waste of space at the payer 100 has a linear relationship to the number of payments he makes. In addition the payer 100 can store receipts for payments he has already made. Under an embodiment of the present invention, a receipt includes <M₁, Mₙ, eᵢ, i>, while under the prior art, a receipt includes <Mⱼ, eᵢ, i>. The space required at the payer 100 for such receipts is quite different for the prior-art vs. the present techniques: For the prior-art, it is: ┌p/h┐×s_{c}+sₕ, and for a present embodiment it is k×s_{c}+sₕ, where k=1 if p≦h, and k=2 otherwise. Thus, the storage requirement increases linearly under the prior art but is constant under embodiments of the present invention.

At the vendor 102 and the broker 104, the space required by an embodiment of the present invention is very different from the requirements under the prior art. In a present embodiment, the broker 104 stores only one timestamp once he has reimbursed the vendor 102 for any reimbursement requests. The vendor 102 also stores only a single timestamp for all reimbursements that have been made to him. (Every future payment he accepts from a payer 100 should have a timestamp that is later than this stored timestamp.) Consequently, in the present embodiment, the space required by the vendor 102 for an un-reimbursed payment transaction is k×s_{c}+sₕ, where k=1 if p≦h, and k=2 otherwise. Under the prior art, the corresponding space requirement is s_{c}×┌p/h┐+sₕ×(1+r), where r is the number of payment transactions for which the vendor 102 has already been reimbursed. Here, r reflects the fact that the vendor 102 stores (the hash of) previous commitments so that he can check against them to detect any attempts by the payer 100 to double spend. Under the prior-art, these r hashes are also stored at the broker 104 to ensure that the vendor 102 does not attempt to get reimbursed more than once for the same payment transaction.

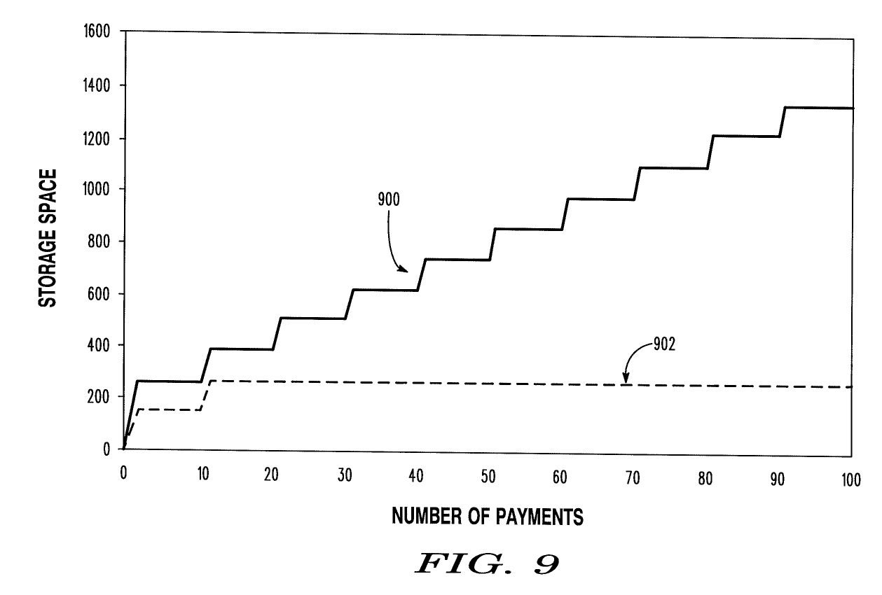

The prior-art and present techniques are identical for the vendor 102 when p≦2 h and r=0. However, for other values of p the space remains constant under the present embodiment but increases linearly under the prior art. This is shown graphically in FIG. 9: curve 900 is for the prior art, while curve 902 is for the present embodiment. (For FIG. 9, h=10 and r=5.) This data storage requirement also affects the communications between the vendor 102 and the broker 104 because the amount of data stored by the vendor 102 is the same as the amount that he transfers to the broker 104 when requesting reimbursement.

To summarize some of the benefits of embodiments of the present invention over the prior art: The vendor 102 reaps tremendous space and data-transfer benefits. The broker 104 processes less data and stores dramatically less data. The payer 100 uses less storage space for receipts for payments already made.

In view of the many possible embodiments to which the principles of this invention may be applied, it should be recognized that the embodiments described herein with respect to the drawing figures are meant to be illustrative only and should not be taken as limiting the scope of the invention. For example, different known hash and cryptographic signature methods may be used. Therefore, the invention as described herein contemplates all such embodiments as may come within the scope of the following claims and equivalents thereof.

We claim:

1. A method for a payer to conduct a payment transaction with a vendor, the method comprising:
signing a first commitment in the payment transaction, the first commitment comprising an anchor of a first hash chain and a verifier;
transmitting to the vendor the signed first commitment;
transmitting to the vendor zero or more payment tokens, each payment token comprising a member of the first hash chain; and
for each of one or more subsequent commitments in the payment transaction:
setting an accumulated count;
signing the subsequent commitment, the subsequent commitment comprising an anchor of a subsequent hash chain, the accumulated count, and a verifier;
transmitting to the vendor the signed subsequent commitment; and
transmitting to the vendor zero or more payment tokens, each payment token comprising a member of the subsequent hash chain.

2. The method of claim 1 wherein signing each commitment comprises signing with a private encryption key.

3. The method of claim 1 wherein the first commitment further comprises an accumulated count.

4. The method of claim 1 further comprising:
transmitting to the vendor a certificate.

5. The method of claim 1 wherein each commitment further comprises a transaction identifier.

6. The method of claim 1 wherein the verifier in each commitment is a timestamp, the timestamp based, at least in part, on a time when the commitment is created.

7. The method of claim 1 wherein the verifier in each commitment is an ordered value, the value in each commitment being a value coming after the values in previous commitments in the payment transaction.

8. The method of claim 1 wherein setting the accumulated count is based, at least in part, on an index of a member of a hash chain, the member transmitted in a payment token in the payment transaction.

9. A method for a vendor to conduct a payment transaction with a payer, the method comprising:
receiving from the payer a signed first commitment, the first commitment comprising an anchor of a first hash chain and a verifier;
verifying that the first commitment was signed by the payer;
verifying the verifier;
for each of zero or more payment tokens received from the payer, verifying that the payment token comprises a valid member of the first hash chain; and
for each of one or more signed subsequent commitments received from the payer, each subsequent commitment comprising an anchor of a subsequent hash chain, an accumulated count, and a verifier:
verifying that the subsequent commitment was signed by the payer;
verifying the verifier;
verifying the accumulated count; and
for each of zero or more payment tokens received from the payer, verifying that the payment token comprises a valid member of the subsequent hash chain.

10. The method of claim 9 wherein verifying that each commitment was signed by the payer comprises applying a public encryption key.

11. The method of claim 9 wherein the first commitment further comprises an accumulated count.

12. The method of claim 9 further comprising:
receiving from the payer a certificate.

13. The method of claim 9 wherein each commitment further comprises a transaction identifier.

14. The method of claim 9 wherein the verifier in each commitment is a timestamp; and
wherein verifying the verifier in the first commitment comprises comparing the verifier to a verification threshold.

15. The method of claim 9 wherein the verifier in each commitment is an ordered value; and
wherein verifying the verifier in the first commitment comprises comparing the verifier to a verification threshold received by the vendor.

16. The method of claim 9 wherein verifying the accumulated count in a subsequent commitment comprises comparing the accumulated count to an accumulated count in an immediately previous commitment in the payment transaction plus an index of a member of a hash chain, the member received in a most recently received payment token in the payment transaction.

17. A method for a vendor to conduct a reimbursement transaction with a broker, the method comprising:
transmitting to the broker a first commitment signed by a payer, the first commitment comprising a first verifier; and
transmitting to the broker a final commitment signed by the payer, the final commitment comprising a final verifier and a final accumulated count.

18. The method of claim 17 wherein the first commitment further comprises a first accumulated count.

19. The method of claim 18 wherein the first commitment is the same as the final commitment.

20. The method of claim 17 wherein the final commitment further comprises an anchor of a final hash chain; the method further comprising:
transmitting to the broker a payment token comprising a valid member of the final hash chain.

21. A method for a broker to conduct a reimbursement transaction with a vendor, the method comprising:
receiving from the vendor a first commitment of a payment transaction, the first commitment comprising a first verifier;
receiving from the vendor a final commitment of the payment transaction, the final commitment comprising a final verifier and a final accumulated count;
verifying the first verifier;
verifying the final verifier;
calculating a reimbursement amount for the reimbursement transaction, the calculating based, at least in part, on the final accumulated count; and
reimbursing to the vendor the calculated reimbursement amount.

22. The method of claim 21 wherein the first commitment further comprises a first accumulated count.

23. The method of claim 22 wherein the calculating is further based, at least in part, on a difference between the final accumulated count and the first accumulated count.

24. The method of claim 22 wherein the first commitment is the same as the final commitment.

25. The method of claim 21 wherein the first verifier and the final verifier are timestamps; and
wherein verifying the first verifier comprises comparing the first verifier to a verification threshold.

26. The method of claim 21 wherein the first verifier and the final verifier are counters; and
wherein verifying the first verifier comprises comparing the first verifier to a verification threshold.

27. The method of claim 21 wherein the final commitment further comprises an anchor of a final hash chain; the method further comprising:
receiving from the vendor a payment token comprising a valid member of the final hash chain;
wherein calculating is further based, at least in part, on an index of the payment token.
